(19) United States
(12) Patent Application Publication
(10) Pub. No.: US 2021/0110144 A1
(43) Pub. Date: Apr. 15, 2021

(54) METHOD AND SYSTEM FOR DETECTING CUSTOMERS NEEDING ATTENTION VIA GESTURE RECOGNITION

(71) Applicant: MASTERCARD INTERNATIONAL INCORPORATED, Purchase, NY (US)

(72) Inventors: Saravana Perumal SHANMUGAM, Fremont, CA (US); Ted P. SANDERS, JR., Wildwood, MO (US); Benard Mukangu MUNYIRI, Nairobe (KE); Alonso ARAUJO, New York, NY (US); Daniel VEGERA, Dublin (IE)

(73) Assignee: MASTERCARD INTERNATIONAL INCORPORATED, Purchase, NY (US)

(21) Appl. No.: 16/599,290

(22) Filed: Oct. 11, 2019

(51) Int. Cl. G06K 9/00; G06Q 30/00; G06K 9/62

(52) U.S. Cl. CPC G06K 9/00335; G06Q 30/016; G06K 2009/00738; G06K 9/00718; G06K 9/6201

(57) ABSTRACT

A method for facilitating customer service interactions through gesture recognition includes: capturing, by an optical imaging device, video data of a physical area, the physical area including one or more individuals; detecting a physical gesture performed by an individual of the one or more individuals based on movement of the individual across multiple frames of the captured video data; identifying a geographic location of the individual in the physical area using at least the captured video data; matching the detected physical gesture to one of a plurality of predetermined gestures; and transmitting a notification message to a computing device including at least the geographic location and the matched one of the plurality of predetermined gestures.

### FIELD

The present disclosure relates to facilitating customer service interactions through gesture recognition, specifically enabling customers in a restaurant or other physical area to indicate a need for assistance through a physical gesture without any direct interaction with a computing device.

### BACKGROUND

In any customer service situation, it can sometimes be difficult for a customer get the attention of an employee or other service provider. One such situation can often be seen in restaurants, where customers typically remain in their designated seats, awaiting assistance from wait staff. If a customer is in need of assistance and the wait staff has not been by, many customers will attempt to locate their waiter or waitress and get their attention, such as by speaking their name, attempting to wave at them, etc. However, such methods are only useful if the customer can actually locate the wait staff and if the wait staff is within range of the customer.

Due to the unreliability of such methods, some companies have implemented alternative methods for a customer to indicate they are in need of assistance. Many businesses with counters used as an interaction point will have a bell or other mechanism used to alert employees that a customer needs assistance. However, this still requires that an employee be in range of the alert system and is only useful when there is a single point of interaction; in a setting where there are several groups of customers it can be impossible for an employee to differentiate sounds. Some restaurants have installed computing devices at their tables that can be used by customers to indicate when they want assistance by making appropriate selections on an interface of the computing device. However, this requires the installation of computing devices at every table, which can be difficult and expensive, is at risk of theft of the computing devices, and requires customers to figure out how to use the computing device, which may be difficult and unintuitive.

Thus, there is a need for a solution that is more intuitive for both customers and employees and that is simpler for a business to implement with their existing systems.

### SUMMARY

The present disclosure provides a description of systems and methods for facilitating customer service interactions through gesture recognition. A business is set up with one or more cameras monitoring a physical area where customers are located. When a customer needs assistance, they can simply make a physical gesture, such as a wave of the hand. The cameras monitor for movement of customers, and will analyze movement as it occurs to match it to predetermined gestures. If a predetermined gesture is performed, an employee is alerted as to the gesture and which customer performed the gesture, as can be identified in the images captured by the cameras. The alert to the employee can identify which customer made the gesture through identification on an image, identification of where the customer is located (e.g., a table number, identified through the location of the customer in the image), or by superimposing an icon or other indication on or near the customer in an augmented reality display. The result is that a customer can simply make a gesture, as many are already accustomed to when trying to get an employee's attention, and an employee can be notified accordingly. The system can be implemented using a camera and one computing device, such as a business's existing customer service system, negating the need for numerous computing devices to be installed and utilized by customers.

A method for facilitating customer service interactions through gesture recognition includes: capturing, by an optical imaging device interfaced with a processing server, video data of a physical area, the physical area including one or more individuals; detecting, by a processing device of the processing server, a physical gesture performed by an individual of the one or more individuals based on movement of the individual across multiple frames of the captured video data; identifying, by the processing device of the processing server, a geographic location of the individual in the physical area using at least the captured video data; matching, by the processing device of the processing server, the detected physical gesture to one of a plurality of predetermined gestures; and transmitting, by a transmitter of the processing server, a notification message to a computing device including at least the geographic location and the matched one of the plurality of predetermined gestures.

A system for facilitating customer service interactions through gesture recognition includes: an optical imaging device configured to capture video data of a physical area, the physical area including one or more individuals; a processing server interfaced with the optical imaging device, the processing server including at least a processing device configured to detect a physical gesture performed by an individual of the one or more individuals based on movement of the individual across multiple frames of the captured video data, identify a geographic location of the individual in the physical area using at least the captured video data, match the detected physical gesture to one of a plurality of predetermined gestures, and transmit a notification message including at least the geographic location and the matched one of the plurality of predetermined gestures; and a computing device configured to receive the transmitted notification message.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for facilitating customer service interactions through gesture recognition accordance with exemplary embodiments.

FIG. 2 is a block diagram illustrating the processing server of the system of FIG. 1 for facilitating customer service interactions through gesture recognition in accordance with exemplary embodiments.

FIG. 3 is a flow diagram illustrating a process for facilitating customer service interactions through gesture recognition in the system of FIG. 1 in accordance with exemplary embodiments.

FIG. 4 is a flow chart illustrating an exemplary method for facilitating customer service interactions through gesture recognition in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Facilitating Customer Service Interactions Through Gestures

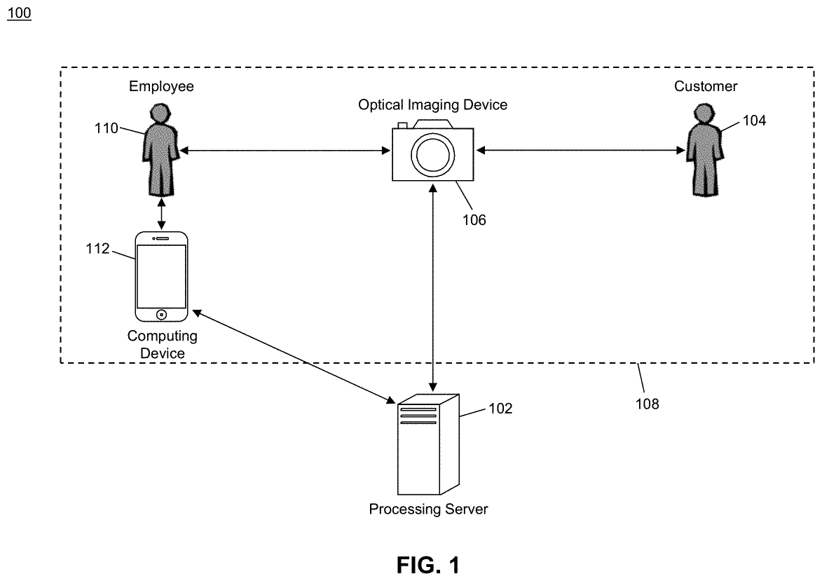

FIG. 1 illustrates a system 100 for facilitating customer service interactions between a customer 104 and an employee 110 of a merchant or other business through the performance of physical gestures by the customer 104.

The system 100 may include a processing server 102. The processing server 102, discussed in more detail below, may be configured to facilitate interactions between the customer 104 and employee 110 by enabling the customer 104 to perform a physical gesture to indicate a requested interaction with the employee 110. In the system 110, one or more optical imaging devices 106 may be installed to monitor a physical area 108. Any type of optical imaging device 106 that is configured to capture a series of images or video of the physical area 108 may be suitable, such as video cameras. For instance, a restaurant or other business may utilize existing security cameras as the optical imaging devices 106, as they capture customer movement in the physical area 108 of the business. The physical area 108 may be any area where customers 104 may be located and where a customer 104 may request a customer service interaction with an employee 110. In a first example, the physical area 108 may be the seating area of a restaurant, where customers 104 try and attract attention from wait staff as the employees 110. In a second example, the physical area 108 may be the floor of a department store, where customers 104 may need shopping assistance from employees 110.

The optical imaging devices 106 may capture video data, either directly as video or through a series of images, of the physical area 108. The optical imaging devices 106 may transmit the captured video or image data to the processing server 102 through a suitable communication network or method. In some cases, the processing server 102 may be physically located in the physical area 108, may be located near the physical area 108 (e.g., in a local communication network with the optical imaging devices 106), or may be externally located, such as accessible by the optical imaging devices 106 using cloud computing techniques. The processing server 102 may receive the video or image data and analyze the data to detect physical gestures performed by customers 104. The processing server 102 may detect movement across frames of the video or in the series of images by a customer 104 and may analyze the movement to see if it matches a predefined physical gesture.

For instance, the processing server 102 may store data regarding a plurality of predefined physical gestures, such as a deliberate wave or a prolonged holding of a hand up in the air. The processing server 102 may analyze movement of customers 104 in the physical area 108 to determine if any movement matches one of the predefined gestures. Thus, movement by customers 104 that do not match the predefined gestures may be ignored. For example, a customer 104 in a restaurant may reach across a table for an item, where the reaching gesture may not match either predefined physical gesture, while a different customer 104 may hold their hand up in the air for a few seconds, which may be detected by the processing server 102 as matching one of the predefined gestures. In such an instance, the processing server 102 will ignore the movement of the first customer 104, but identify the second customer 104 as performing the predefined gesture. Methods for analyzing movement and matching movement to predefined gestures will be apparent to persons having skill in the art.

When the processing server 102 detects that a predefined gesture has been performed, the processing server 102 may identify a geographic location in the physical area 108 where the customer 104 that made the gesture is located. In some cases, the geographic location may be represented directly, such as identifying the customer's precise location in a captured image or video of the physical area 108. In other cases, the geographic location may be represented in a different format that may be suitable to employees. For example, if the physical area 108 is a seating area in a restaurant, the geographic location of the customer 104 can be identified as where they are seated in a picture of the seating area, or as a table number that is identified based on a check of the geographic location against stored data. For instance, the processing server 102 may have a database therein of all tables in a seating area and their geographic location in images captured by optical imaging devices 106, where the table where a customer 104 is located can be identified based on the customer's location in a captured image or video.

Once the geographic location of the customer 104 has been identified, the processing server 102 may electronically transmit a notification to a computing device 112. The computing device 112 may be any type of device specially configured to perform the functions discussed herein, such as a specially configured desktop computer, laptop computer, notebook computer, tablet computer, cellular phone, smart phone, smart watch, smart television, wearable computing device, etc. For instance, the computing device 112 may be a point of sale system used by a merchant, a smart phone or other device carried by an employee 110, a smart display device that is displayed in an employee area of the business, etc. The notification may be transmitted to the computing device 112 and displayed or otherwise conveyed to an employee 110, where the notification indicates at least the physical gesture that was performed by the customer 104 and the geographic location of the customer 104 in the physical area 108.

The indication of the physical gesture may indicate the gesture itself (e.g., the customer 104 raised their hand in the air) or it may display information to the employee 110 associated with the predefined gesture. For example, if customer 104 makes a deliberate wave, the notification may indicate that the customer 104 generally needs assistance, but if the customer 104 mimics writing a checkmark with their fingers, the notification may indicate that the customer 104 wants their bill. The geographic location of the customer 104 may be conveyed using any suitable format, such as by displaying a captured image or video data with an icon or other indication of the customer 104 located therein, or by displaying an alternative representation of the geographic location (e.g., the table number where the customer 104 is seated). For example, a notification may be displayed on the computing device 112 to the employee 110 stating that “A customer at table 58 wants their check” once the customer 104, located at table 58 as determined by their location in the physical area 108 determined from a captured image, mimics writing a checkmark in the air. The employee 110 may then be free to provide the requested assistance to the customer 104.

In some embodiments, the system 100 may utilize augmented reality to provide assistance to customer 104. For example, an employee 110 may wear glasses or some other display device that can display superimposed images on the physical area 108 as being viewed by the employee 110. In such an example, the computing device 112 may, based on the notification received from the processing server 102, display an icon above the head of the customer 104 on the superimposed, augmented reality display, regarding the physical gesture. For instance, if the customer 104 mimicked writing a checkmark, an icon may be displayed over the customer 104 in the employee's augmented reality display that indicates that the customer 104 wants their bill. As a result, when a customer 104 makes a gesture, the employee 110 will be able to “see” that they made a gesture the next time they look in the customer's direction, even if the customer 104 made the gesture before the employee 110 was in or near the physical area 108. In some cases, the employee 110 may receive a notification prior to seeing the displayed icon. For instance, the augmented reality display may provide a text notification (e.g., “A customer at table 58 wants their check”) that informs the employee 110 to look at the customer 104. In some cases, the augmented reality display may display an arrow or other directional indicator that guides the employee's vision towards an icon or other indicator located at a customer 104 that has performed a physical gesture.

Even in cases where augmented reality may not be used, notifications may be provided to employees in similar fashions. For instance, a restaurant may use a central display device to inform all employees 110 of physical gestures performed by customers 104 (e.g., a list of all customers 104 that have requested assistance), but may also transmit notifications directly to necessary employees 110. For instance, in the above restaurant example, the employee 110 that is assigned to table 58 may receive a notification on an assigned computing device 112 that one of their customers 104 has requested their bill, while the message that “A customer at table 58 wants their check” may still be displayed to all employees 110, such that a fellow employee 110 can assist the customer 104 if the assigned employee is currently busy. In some cases, employees 110 may be able to clear out a notification once assistance has been provided to the customer 104, which may remove the notification from the computing device 112, including removing the icon from an augmented reality display. In some embodiments, an employee 110 may be able to perform a physical gesture that may be recognized by the optical imaging devices 106 and the processing server 102 to clear out a notification.

In some embodiments, an employee 110 may be provided with additional information beyond the physical gesture performed and a geographic location of the customer 104. For instance, in the restaurant example, if a customer 104 seated at table 58 makes a deliberate wave for assistance, the notification to the employee 110 may state that a customer 104 at table 58 needs assistance, but may also provide information regarding the customer's current order, loyalty information, name, etc., in an effort to provide greater assistance to the customer 104. For example, the employee 110 may input the customer's name, their order, and any other relevant information into the computing device 112, where such information may be displayed along with the notification to assist the employee 110 in providing assistance. In such an example, the employee 110 can quickly go to the customer 104 and inform them, by name, of the status of their order in the kitchen (e.g., as it may be updated in the computing device 112 by kitchen staff), and ask what they need assistance with. Thus, the methods and systems herein provide for more comprehensive customer service that is more convenient for both customers 104 and employees 110, and can be implemented using existing optical imaging devices 106 by use of the specially configured processing server 102 and computing devices 112 that are configured to receive notification messages therefrom.

### Processing Server

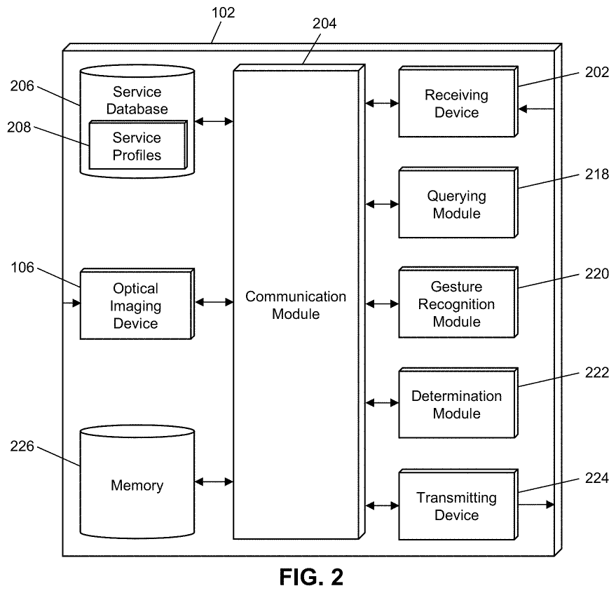

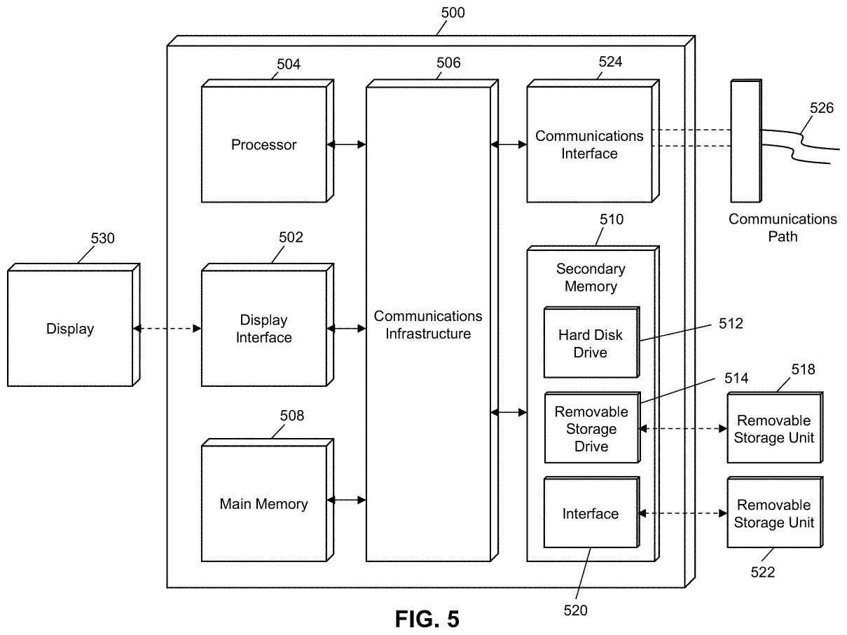

FIG. 2 illustrates an embodiment of a processing server 102 in the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 500 illustrated in FIG. 5 and discussed in more detail below may be a suitable configuration of the processing server 102.

The processing server 102 may include a receiving device 202. The receiving device 202 may be configured to receive data over one or more networks via one or more network protocols. In some instances, the receiving device 202 may be configured to receive data from optical imaging devices, computing devices 112, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by optical imaging devices 106 that are superimposed or otherwise encoded with video data or a series of images corresponding to video data that capture movement performed by customers 104 in a physical area 108. The receiving device 202 may also be configured to receive data signals electronically transmitted by computing devices 112, which may be superimposed or otherwise encoded with updates to physical gestures, geographic location information for the physical area 108 (e.g., table locations in a restaurant seating area), notification rules for computing devices 112, etc.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 218, gesture recognition module 220, determination module 222, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may include a service database 206. The service database 206 may be configured to store a plurality of service profiles 208 using a suitable data storage format and schema. The service database 206 may be a relational database that utilizes structured query language for the storage, identification, modifying, updating, accessing, etc. of structured data sets stored therein. Each service profile 208 may be a structured data set configured to store data related to a customer 104 or geographic location in the physical area 108, such as may include status information, customer information, loyalty information, or any other data that may be useful to employees 110 when providing service to customers 104 that have performed a physical gesture while in the physical area 108. For example, for a restaurant a service profile 208 may include order information for a table or past ordering history for a customer 104, or for a department store a service profile 208 may include shopping information for a customer 104, such as sizing information, brand preferences, color preferences, etc.

The processing server 102 may be interfaced with one or more optical imaging devices 106. Each optical imaging device 106 may be configured to capture video data that may be transmitted to one or more modules or engines of the processing server 102 using the communication module 204. In some cases, optical imaging devices 106 may be part of the processing server 102, such as enclosed in a single device or physically interfaced therewith. In other cases, optical imaging devices 105 may be external to the processing server 102, but in communication therewith through direct communication or a local communication network, or through an alternative communication method, such as via cloud computing. For example, the optical imaging devices 106 may be located at the physical area 108, but the processing server 102 may not be located anywhere near the physical area 108 and in communication with the optical imaging devices 106 and computing devices 112 via the Internet or other suitable method.

The processing server 102 may include a querying module 218. The querying module 218 may be configured to execute queries on databases to identify information. The querying module 218 may receive one or more data values or query strings, and may execute a query string based thereon on an indicated database, such as the service database 206 of the processing server 102 to identify information stored therein. The querying module 218 may then output the identified information to an appropriate engine or module of the processing server 102 as necessary. The querying module 218 may, for example, execute a query on the service database 206 to identify information regarding a customer 104 or geographic location, or to execute a query on a memory 226 to identify a predefined gesture that matches movement of a customer 104.

The processing server 102 may also include a gesture recognition module 220. The gesture recognition module 220 may be configured to recognize physical gestures being performed by customers 104 in physical movements in video data captured by the interfaced optical imaging devices 106 and provided therefrom. The gesture recognition module 220 may receive the video data as input, may detect movement in the video data by a customer 104, may recognize a gesture as a series of deliberate movements performed by the customer 104, and may output the detected gesture to another module or engine of the processing server 102.

The processing server 102 may also include a determination module 222. The determination module 222 may be configured to perform determinations for the processing server 102 as discussed herein. The determination module 222 may be configured to receive data for use in a determination as input, make a determination based on the data, and may output a result of the determination to another module or engine of the processing server 102. For example, the determination module 222 may be configured to determine if a physical gesture performed by a customer 104 (e.g., as identified by the gesture recognition module 220) matches a predefined gesture (e.g., stored in the memory 226 as identified by the querying module 218). The determination module 222 may also be configured to determine a geographic location of a customer 104 that performed a physical gesture based on image and video data for the physical area 108.

The processing server 102 may also include a transmitting device 224. The transmitting device 224 may be configured to transmit data over one or more networks via one or more network protocols. In some instances, the transmitting device 224 may be configured to transmit data to optical imaging devices 106, computing devices 112, and other entities via one or more communication methods, local area networks, wireless area networks, cellular communication, Bluetooth, radio frequency, the Internet, etc. In some embodiments, the transmitting device 224 may be comprised of multiple devices, such as different transmitting devices for transmitting data over different networks, such as a first transmitting device for transmitting data over a local area network and a second transmitting device for transmitting data via the Internet. The transmitting device 224 may electronically transmit data signals that have data superimposed that may be parsed by a receiving computing device. In some instances, the transmitting device 224 may include one or more modules for superimposing, encoding, or otherwise formatting data into data signals suitable for transmission.

The transmitting device 224 may be configured to electronically transmit data signals to optical imaging devices 106 that are superimposed or otherwise encoded with requests for video data. The transmitting device 224 may also be configured to electronically transmit data signals to computing devices 112 that are superimposed or otherwise encoded with notifications, such as may include indications of a predefined gesture performed by a customer 104 at an indicated geographic location, which may further include any additional information that may be available to the processing server 102, such as customer information or status information.

The processing server 102 may also include a memory 226. The memory 226 may be configured to store data for use by the processing server 102 in performing the functions discussed herein, such as public and private keys, symmetric keys, etc. The memory 226 may be configured to store data using suitable data formatting methods and schema and may be any suitable type of memory, such as read-only memory, random access memory, etc. The memory 226 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 226 may be comprised of or may otherwise include a relational database that utilizes structured query language for the storage, identification, modifying, updating, accessing, etc. of structured data sets stored therein. The memory 226 may be configured to store, for example, communication data for optical imaging devices 106 and computing devices 112, predefined gestures, gesture recognition algorithms, geographic location data, etc.

### Process for a Customer Service Interaction Facilitated Through Gestures

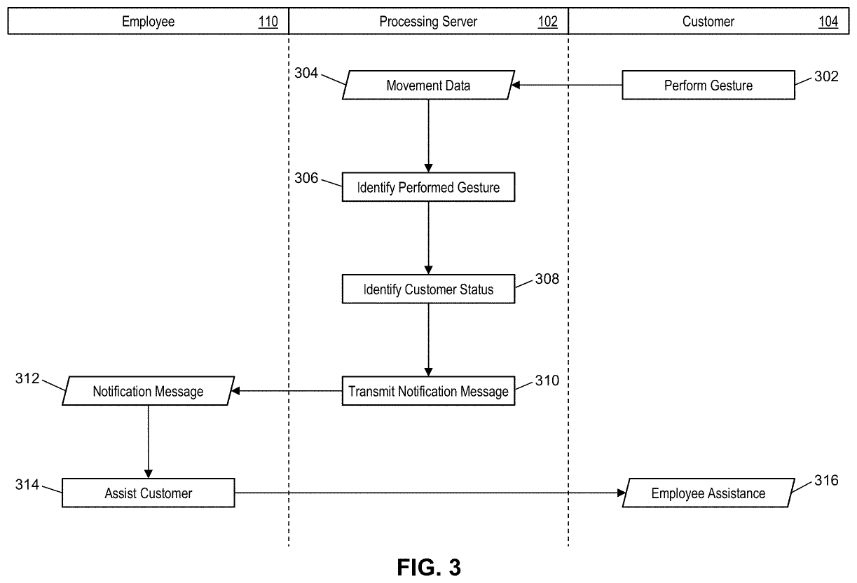

FIG. 3 illustrates an example process in the system 100 of FIG. 1 for the carrying out of a customer service interaction that is initiated through the performance of a predefined physical gesture by the customer 104 in the physical area 108.

In step 302, the customer 104 may perform a physical gesture while located in the physical area 108. The physical gesture may be captured by one or more optical imaging devices 106 that view the physical area 108 and, in step 304, the captured physical gesture may be transmitted to the processing server 102 and received by the receiving device 202 thereof. In step 306, the gesture recognition module 220 of the processing server 102 may identify the physical gesture that was performed by the customer 104 and the determination module 222 of the processing server 102 may determine that the physical gesture matches a predefined gesture, such as stored in the memory 226 of the processing server 102.

In step 308, the determination module 222 of the processing server 102 may determine the geographic location of the customer 104 in the physical area 108 based on the movement data, and the querying module 218 of the processing server 102 may execute a query on the service database 206 to identify a service profile 208 for the geographic location to identify status of the customer 104 as stored therein. In step 310, the transmitting device 224 of the processing server 102 may electronically transmit a notification message to the employee 110 via a computing device 112 associated therewith. The notification message may include at least the identified customer status as well as the geographic location of the customer 104 and the predefined gesture that was performed by the customer 104.

In step 312, the employee 110 may receive the notification message. The employee 110 may then, in step 314, provide assistance to the customer 104 utilizing the information provided in the notification message regarding the customer's status and the assistance they requested based on the predefined gesture that was performed. In step 316, the customer 104 may receive the assistance provided by the employee 110 as a result of their performing the predefined gesture in the physical area 108.

### Exemplary Method for Facilitating Customer Service Interactions Through Gesture Recognition

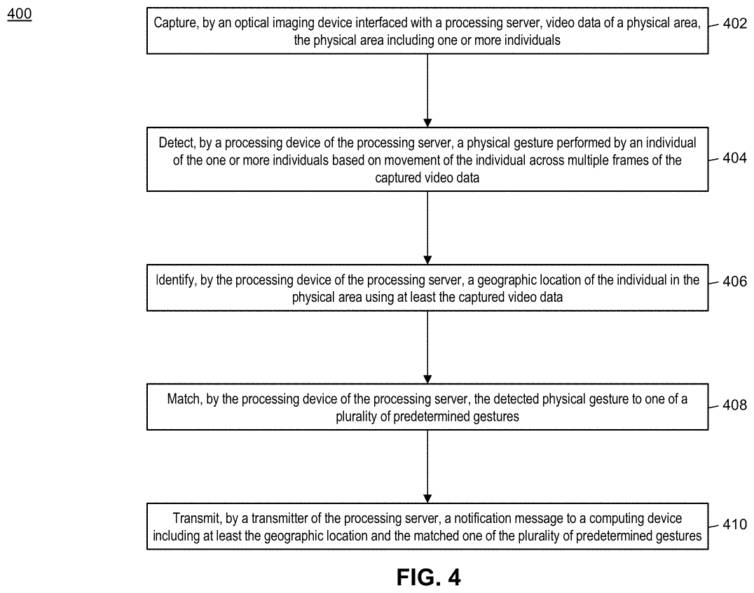

FIG. 4 illustrates a method 400 for facilitating a customer service interaction for a customer located in a physical area as a result of the performance of a physical gesture performed by the customer.

In step 402, video data of a physical area (e.g., the physical area 108) may be captured by an optical imaging device (e.g., optical imaging device 106) interfaced with a processing server (e.g., the processing server 102), the physical area including one or more individuals (e.g., customers 104). In step 404, a physical gesture performed by an individual of the one or more individuals may be detected by a processing device (e.g., the gesture recognition module 220) of the processing server based on movement of the individual across multiple frames of the captured video data.

In step 406, a geographic location of the individual in the physical area may be identified by the processing device (e.g., the determination module 222) of the processing server using at least the captured video data. In step 408, the detected physical gesture may be matched by the processing device (e.g., the determination module 222 or querying module 218) to one of a plurality of predetermined gestures. In step 410, a notification message may be transmitted by a transmitter (e.g., the transmitting device 224) of the processing server to a computing device (e.g., the computing device 112) including at least the geographic location and the matched one of the plurality of predetermined gestures.

In one embodiment, the notification message may include an image of the physical area, and the geographic location may be indicated in the image of the physical area. In a further embodiment, an icon associated with the matched one of the plurality of predetermined gestures may be displayed at the geographic location in the image of the physical area. In some embodiments, the computing device may be interfaced with a display device configured to display an icon at the geographic location in the physical area using augmented reality. In a further embodiment, the icon may be associated with the matched one of the plurality of predetermined gestures.

In one embodiment, the method 400 may further include storing, in a service database (e.g., the service database 206) of the processing server, a plurality of service profiles (e.g., service profiles 208), wherein each service profile includes at least a geographic area in the physical area and a service provider identifier. In a further embodiment, the computing device may be associated with a service provider corresponding to the service provider identifier included in a service profile where the included geographic area contains the geographic location. In another further embodiment, each service profile may further include a service status, and the notification message may further include the service status.

### Computer System Architecture

FIG. 5 illustrates a computer system 500 in which embodiments of the present disclosure, or portions thereof, may be implemented as computer-readable code. For example, the processing server 102 of FIG. 1 may be implemented in the computer system 500 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3 and 4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for facilitating customer service interactions through gesture recognition. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for facilitating customer service interactions through gesture recognition, comprising:
capturing, by an optical imaging device interfaced with a processing server, video data of a physical area, the physical area including one or more individuals;
detecting, by a processing device of the processing server, a physical gesture performed by an individual of the one or more individuals based on movement of the individual across multiple frames of the captured video data;
identifying, by the processing device of the processing server, a geographic location of the individual in the physical area using at least the captured video data;
matching, by the processing device of the processing server, the detected physical gesture to one of a plurality of predetermined gestures; and
transmitting, by a transmitter of the processing server, a notification message to a computing device including at least the geographic location and the matched one of the plurality of predetermined gestures.

2. The method of claim 1, wherein
the notification message includes an image of the physical area, and
the geographic location is indicated in the image of the physical area.

3. The method of claim 2, wherein an icon associated with the matched one of the plurality of predetermined gestures is displayed at the geographic location in the image of the physical area.

4. The method of claim 1, wherein
the computing device is interfaced with a display device configured to display an icon at the geographic location in the physical area using augmented reality.

5. The method of claim 4, wherein the icon is associated with the matched one of the plurality of predetermined gestures.

6. The method of claim 1, further comprising:
storing, in a service database of the processing server, a plurality of service profiles, wherein each service profile includes at least a geographic area in the physical area and a service provider identifier.

7. The method of claim 6, wherein the computing device is associated with a service provider corresponding to the service provider identifier included in a service profile where the included geographic area contains the geographic location.

8. The method of claim 6, wherein
each service profile further includes a service status, and
the notification message further includes the service status.

9. A system for facilitating customer service interactions through gesture recognition, comprising:
an optical imaging device configured to capture video data of a physical area, the physical area including one or more individuals;
a processing server interfaced with the optical imaging device, the processing server including at least
a processing device configured to
detect a physical gesture performed by an individual of the one or more individuals based on movement of the individual across multiple frames of the captured video data,
identify a geographic location of the individual in the physical area using at least the captured video data,
match the detected physical gesture to one of a plurality of predetermined gestures, and
transmit a notification message including at least the geographic location and the matched one of the plurality of predetermined gestures; and
a computing device configured to receive the transmitted notification message.

10. The system of claim 1, wherein
the notification message includes an image of the physical area, and
the geographic location is indicated in the image of the physical area.

11. The system of claim 10, wherein an icon associated with the matched one of the plurality of predetermined gestures is displayed at the geographic location in the image of the physical area.

12. The system of claim 9, wherein
the computing device is interfaced with a display device configured to display an icon at the geographic location in the physical area using augmented reality.

13. The system of claim 12, wherein the icon is associated with the matched one of the plurality of predetermined gestures.

14. The system of claim 9, wherein the processing server includes a service database configured to store a plurality of service profiles, wherein each service profile includes at least a geographic area in the physical area and a service provider identifier.

15. The system of claim 14, wherein the computing device is associated with a service provider corresponding to the service provider identifier included in a service profile where the included geographic area contains the geographic location.

16. The system of claim 14, wherein
each service profile further includes a service status, and
the notification message further includes the service status.
